(19) United States
(12) Patent Application Publication
(10) Pub. No.: US 2004/0143992 A1
(43) Pub. Date: Jul. 29, 2004

(54) Laundry drier control method

(76) Inventor: Gi Hyeong Do, Changwon-si (KR)

Correspondence Address: Song K. Jung, MCKENNA LONG & ALDRIDGE LLP, 1900 K Street, N.W., Washington, DC, 20006, US

(21) Appl. No.: 10/717,610

(22) Filed: Nov. 21, 2003

(30) Foreign Application Priority Data
Nov. 26, 2002 (KR) P 2002-0074067

(51) Int. Cl. F26B 3/00

(52) U.S. Cl. 34/446

(57) ABSTRACT

A laundry drier control method reads a temperature variation rate per unit time, to enable drying according to the amount and type of an object being dried. The method includes steps of initiating a drying procedure; measuring a temperature variation rate per unit time over the drying procedure; calculating an overall drying time based on the measured temperature variation rate per unit time; and performing the drying procedure for the calculated overall drying time. The drying time determining step is repeated if a substantial increase in the temperature variation rate is detected.

This application claims the benefit of Korean Application No. 10-2002-0074067 filed on Nov. 26, 2002, which is hereby incorporated by reference.

### BACKGROUND OF THE INVENTION

1. Field of the Invention

The present invention relates to a laundry drier, and more particularly, to a laundry drier control method in which a temperature variation rate per unit time is used to control drying time as needed.

2. Discussion of the Related Art

A laundry drier is an apparatus for drying wet objects, e.g., clothes, after completion of a washing cycle or the like. FIGS. 1 and 2 illustrate a laundry drier according to a related art, with FIG. 2 showing a cross-section taken along a line I-I in FIG. 1.

Referring to FIGS. 1 and 2, a drier according to a related art is comprised of a body 100 having an entrance 101 at a front side in which a door 105 is installed, a drum 30 rotatably installed in the body and having a plurality of stirrers 30a protruding from an inner circumferential surface of the drum, a motor 50 fixed to an inner side surface of the body to generate and transfer via a belt 60 a slow and directionally controllable rotational force with respect to the drum, first and second hot air passages 10a and 10b for guiding an air flow of external air (10a) to drum's interior to be discharged (10b) to the exterior of the laundry drier, a heater 20 installed inside the first hot air passage to heat the air therein, and an exhaust fan 40 for generating a forcible blowing force to discharge air through the second hot air passage and thereby draw in external air through the first hot air passage.

Referring to FIG. 3, illustrating a laundry drying method according to the related art, with wet laundry placed in the drum 30, drying is initiated in a step S10 to actuate each of the exhaust fan 40, the heater 20, and the motor 50. As the exhaust fan 40 starts to operate, external air is drawn in through the first hot air passage 10a, where it is heated by passing through the heater 20 and forcibly led into the drum 30, to evaporate the water content of laundry placed therein. Thus, the drying action is realized by a negative blowing force of the exhaust fan 40, whereby a circulation of air is achieved by drawing in external air through the first hot air passage 10a and discharging the air through the second hot air guide passage 10b. Meanwhile, the drum 30 is rotated according to a predetermined cycle, and the stirrers 30a pull the laundry up one side of the drum's interior to fall back down into a lower area thereof. The laundry is dried in a step S20 through the above-explained process.

As drying thus proceeds, if it is determined in a step S30 that a predetermined time has passed, the heater 20 and motor 50 are stopped in a step S40. Here, the exhaust fan 40 continues to operate for a fixed predetermined time of say, five minutes, to perform a cooling of the interior of the laundry drier in a step S50, after which the door 105 may be opened. Thus, the cooling is performed according to a procedure similar to that of the steps S20˜S40 in which a constant operation is continued for a fixed duration.

As above, the laundry drier of the related art completes its assigned task by execution according to a predetermined time. That is, the drying procedure is performed for a fixed time, as set by the manufacturer, regardless of the amount or type of laundry being dried. Therefore, drying may be incomplete or excessive.

### SUMMARY OF THE INVENTION

Accordingly, the present invention is directed to a method of controlling drying time of a drier that substantially obviates one or more of the problems due to limitations and disadvantages of the related art.

An object of the present invention, which has been devised to solve the foregoing problem, lies in providing a laundry drier control method which, by reading a temperature variation rate per unit time, dynamically varies the drying time according to the amount and type of an object being dried.

It is another object of the present invention to provide a laundry drier control method, by which drying is performed accurately according to the amount and type of object being dried.

It is another object of the present invention to provide a laundry drier control method, by which a proper drying is determined according to the amount and type of object being dried.

It is another object of the present invention to provide a laundry drier control method, by which improved drier operation can be achieved.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a laundry drier control method comprising steps of initiating a drying procedure; measuring a temperature variation rate per unit time over the drying procedure; calculating an overall drying time based on the measured temperature variation rate per unit time; and performing the drying procedure for the calculated overall drying time.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a laundry drier according to a related art;

FIG. 2 is a cross-sectional view along a line I-I in FIG. 1;

FIG. 3 is a flow chart of a laundry drying control method according to a related art;

FIG. 4 is a block diagram of a laundry drier according to the present invention;

FIG. 5 is a graph of temperature over time, showing respective temperature plots for a relatively short drying time and a relatively long drying time, occurring in a laundry drier adopting a control method according to the present invention; and

FIG. 6 is a flowchart of a laundry drier control method according to the present invention.

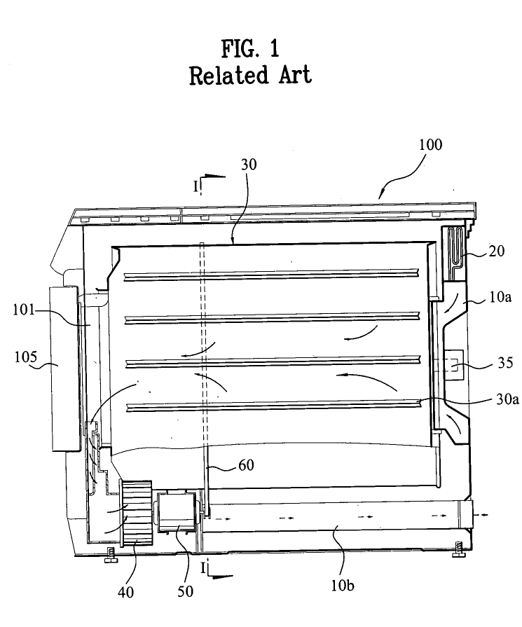

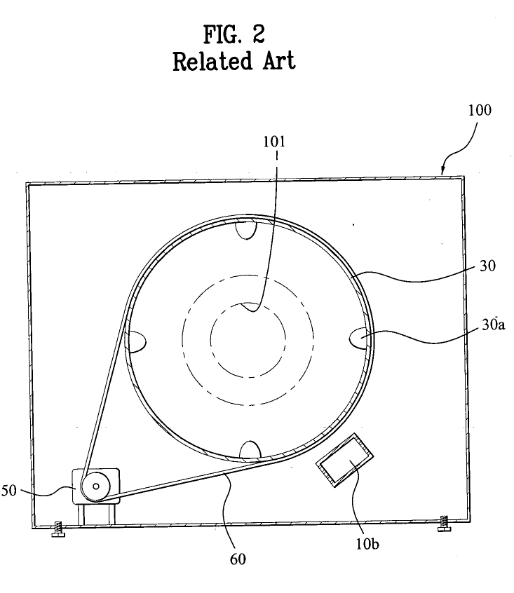

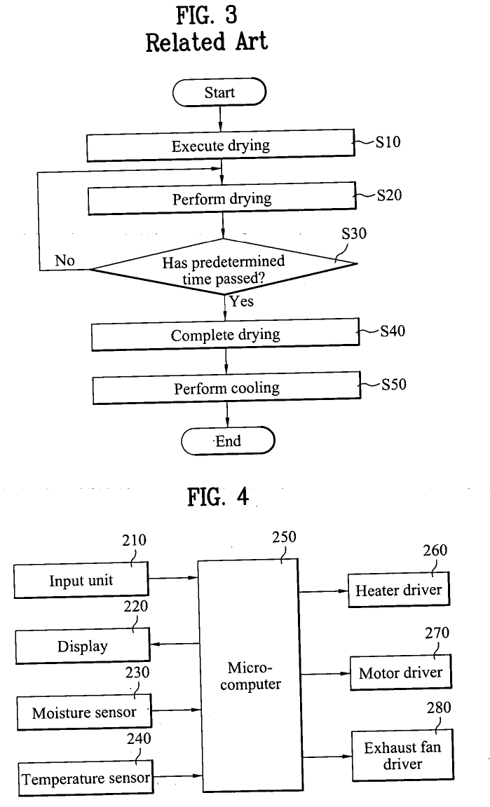

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

A laundry drier control method according to the present invention reads a temperature variation rate per unit time to adjust a drying time of a drying procedure according to an amount and type of objects, i.e., laundry, being dried. That is, a drying procedure according to the method of the present invention is controlled such that a drying time is determined using a temperature variation rate per unit time, from the point of initiating the drying procedure.

Referring to FIG. 4, a laundry drier adopting the control method according to the present invention is comprised of an input unit 210 for inputting user commands, a display 220 for displaying the respective operational states of drying and cooling procedures based on the input user commands, a moisture sensor 230 for measuring the water content of laundry during the drying procedure and for outputting a sensed water content signal, a temperature sensor 240 for detecting an internal temperature during the drying and cooling procedures and for outputting a sensed temperature signal, a microcomputer 250 for controlling the drying and cooling procedures based on the sensed signals and user command input, to determine the state of the drying procedure and to control accordingly each of heater, motor, and exhaust fan drivers 260, 270, and 280.

Upon initiating a drying procedure, the microcomputer 250 reads the temperature sensed by the temperature sensor 240 according to the drying time, whereby the temperature variation (slope) differs as the drying of a drying object proceeds. That is, the temperature varies sharply as the drying object begins to dry, varies more gradually when the drying object is substantially dried, and again varies sharply as the drying object nears a dry state.

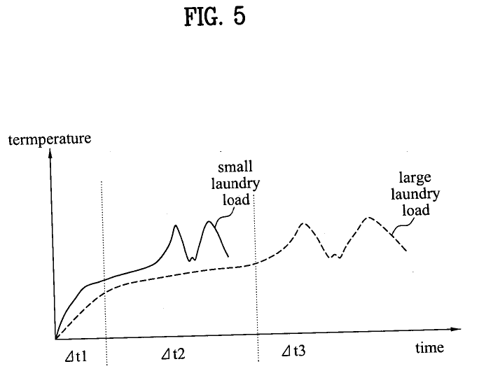

Referring to FIG. 5, a time period Δt1 is a period for preheating the drying object, a time period Δt2 is a period during which the drying object is substantially dried at a peak drying temperature, and a time period Δt3 is a period for high temperature drying that continues for a predetermined time after the peak drying temperature. Based on such a drying procedure, a laundry drier adopting the control method according to the present invention differentially drives the heater and motor drivers 260 and 270 for the preheating and peak drying temperature periods (Δt1 and Δt2) and for the high temperature drying period (Δt3), according to whether a maximum drying temperature has been reached.

Specifically, a laundry drier adopting the control method according to the present invention determines a proper drying time by sensing the variation of the temperature per unit time as the drying procedure progresses as well as sensing any change in the temperature variation rate per unit time. The temperature variation rate per unit time, measured from the initiation of the drying procedure, decreases over time at a known rate, and after a predetermined time passes, the temperature variation rate per unit time increases when the drying object is nearly dry. This increase in temperature variation rate per unit time is used to calculate the remaining drying time and in turn an overall drying time. In other words, when a small laundry load is being dried, the drying time is reduced since the increase in the temperature variation rate per unit time occurs sooner than when a large laundry load is being dried, and vice versa.

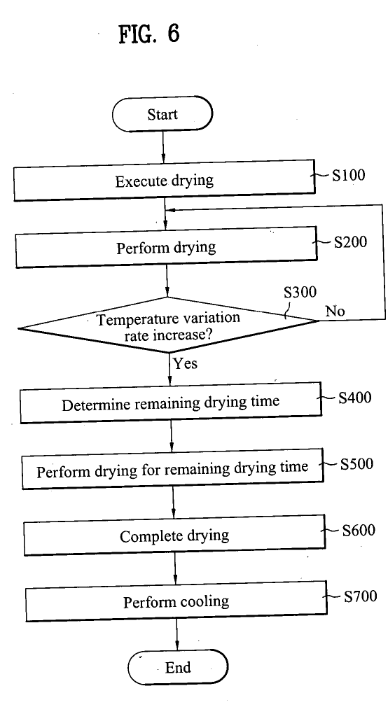

Referring to FIG. 6, illustrating a laundry drier control method according to the present invention, with the drying object placed in the drum 30, the input unit 210 is manipulated to initiate the drying procedure in a step S100, thus actuating the heater and motor drivers 270 and 280. In doing so, the temperature sensor 240 immediately begins outputting a sensed temperature signal to the microcomputer 250, indicating the drying temperature effected within the drum 30, and the microcomputer determines a drying temperature variation rate per unit time. In a step S200, shortly after initiating the drying procedure, the temperature rapidly rises (high rate) to a predetermined temperature set according the input from the input unit 210, and upon reaching the predetermined temperature, the drying of the drying object continues until there is no substantial variation (low rate) of the temperature. That is, based on the sensed temperature signal output from the temperature sensor 240, the microcomputer 250 determines in a step S300 whether the high temperature variation rate per unit time has been sufficiently reduced. A substantially increased rate of temperature variation indicates that the temperature inside the drier is rapidly rising, signaling that the drying object is nearly dry.

As soon as an increase in the temperature variation rate per unit time is detected, the remaining drying time is calculated in a step S400. In a step 500, the drying procedure continues for the calculated remaining time, until completion in a step S600. The microcomputer 210 then controls the display 220 to display a “drying complete” status, and the operation of the heater and motor drivers 260 and 270 is stopped. Operation of the exhaust fan driver 280 continues for a cooling procedure according to a step S700.

Accordingly, the laundry drier control method of the present invention determines the drying time after an increase in the temperature variation rate per unit time with respect to the rate at the time of initiating the drying procedure. Hence, the overall drying time can be dynamically controlled, to differentiate the drying time according to the amount and type of laundry put in the drier. Thus, an improved operation of a laundry drier is achieved by determining a proper drying time whereby drying time is reduced when the drying object (laundry load) is small or can be dried quickly and is increased for larger loads or loads that may take longer to dry.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A laundry drier control method comprising steps of:
initiating a drying procedure;
measuring a temperature variation rate per unit time over the drying procedure;
calculating an overall drying time based on the measured temperature variation rate per unit time; and
performing the drying procedure for the calculated overall drying time.

2. The method as claimed in claim 1, wherein said calculating step is repeated if a substantial increase in the temperature variation rate is detected.

3. The method as claimed in claim 1, wherein the temperature variation rate is 1° C. per minute.
